(19) United States
(12) Patent Application Publication
(10) Pub. No.: US 2014/0056608 A1
(43) Pub. Date: Feb. 27, 2014

(54) IMAGE FORMING APPARATUS

(71) Applicant: CANNON KABUSHIKI KAISHA, Tokyo (JP)

(72) Inventor: Yukihiro Miura, Toride-shi (JP)

(73) Assignee: CANON KABUSHI KAISHA, Tokyo (JP)

(21) Appl. No.: 13/964,552

(22) Filed: Aug. 12, 2013

(30) Foreign Application Priority Data
Aug. 24, 2012 (JP) 2012-185062

(51) Int. Cl. G03G 21/20

(52) U.S. Cl. CPC G03G 15/205
USPC 399/92

(57) ABSTRACT

An image forming apparatus includes an imaging station for forming a toner image on a sheet using toner containing a parting material; a fan for discharging air adjacent the fixing portion to an outside of the apparatus; and a controller capable of executing an operation in a first control mode in which a driving speed of the fan is changed in a set range in accordance with a temperature adjacent the imaging station, and in a second control mode in which the driving speed of the fan set at an upper limit speed in the set range irrespective of the information corresponding to the temperature adjacent the imaging station.

### FIELD OF THE INVENTION AND RELATED ART

The present invention relates to an image forming apparatus which forms a toner image on a sheet of recording medium.

Image forming apparatuses are apparatuses which form an image on a sheet of recording medium with the use of an image formation process based on a suitable image formation principle/method, more concretely, an electrophotographic image formation process, an electrostatic image recording process, a magnetic image recording process, or the like, and developer. Some image formation apparatuses form an image directly on a sheet of recording medium, and others form an image on an intermediary transfer member, and then, transfer the image onto a sheet of recording medium. They include a copying machine, a printer (laser beam printer, LED printer, etc.), a facsimile machine, a multifunction machine capable of performing as two or more of the preceding machines, a word processor, and an image displaying apparatus (electronic blackboard, electronic whiteboard, electronic display, etc.), for example.

Recording medium is medium on which an image can be formed of toner (developer) by an image forming apparatus. It includes a sheet of ordinary paper, a sheet of cardstock, an envelop, a postcard, a seal, a sheet of transparency, a sheet of electrophotographic facsimile paper, and a sheet of electrostatic recording paper, for example.

Hereinafter, the present invention is described with reference to an electrophotographic image forming apparatus. It has been common practice that an electrophotographic image forming apparatus heats an unfixed toner image it formed on a sheet of recording medium to permanently fix the toner image to the sheet of recording medium during an image forming operation. During a printing operation, the fixing member of the fixing device of the image forming apparatus, which is a fixing means, is controlled in temperature so that its temperature remains in a range of 150-200° C.

It has been known that it is possible that while the temperature of the fixing device is kept in the abovementioned high range, particles (which hereafter will be referred to simply as “dust”), which are no more than 0.1 μm in size, are generated. It is thought that the generation of these particles is attributable to the parting agent (wax) added to the material for the toner to improve the toner in parting properties, that is, to make it easier for the toner to separate from the fixing member. That is, it is thought that when a toner image is heated to be fixed, the wax in the toner particles evaporates, and turns into minute particles of wax.

In recent years, for energy conservation, while a fixing device is kept on standby, it is put to sleep, that is, its heating system is temporarily stopped. That is, recent fixing devices are structured so that they are operated only when they are needed for image formation. In other words, the recent fixing devices are of the so-called on-demand type, which can be quickly started, that is, it can be readied for fixation in a very short length of time (several tens of seconds).

The inventors of the present invention discovered that if an image formation job is started when the ambient temperature of a fixing device of the on-demand type is cold (approximately room temperature), it is relatively large in the amount of dust generation, but, it gradually reduces in the amount of dust generation as the ambient temperature of the fixing device increases.

Japanese Laid-open Patent Application 2010-117421, which is not directly related to the “dust”, proposes a method for preventing the VOC (volatile organic compounds) which generates from a sheet of recording medium during fixation, from leaking out of the device. According to this patent application, in a case where a sheet of recording medium which is likely to be large in the VOC generation amount is used, the exhaust fan is reduced in the number of revolutions to increase the filter in the VOC capture efficiency. This exhaust fan functions also as the system for removing the heat in the image forming apparatus from the image forming apparatus (in order to prevent image formation station from excessively increasing in temperature).

However, as described above, the generation of the “dust” is attributable to the parting agent in the toner particles. Therefore, taking a measure such as the one disclosed in Japanese Laid-open Patent Application 2010-117421 is insufficient to deal with the “dust”.

That is, in a case where an image is formed when the ambient air of a fixing device is cool, for example, immediately after the main power source of an image forming apparatus was turned on, the image forming apparatus is not in a state in which heat has to be removed from the apparatus. Therefore, if the exhaust fan is reduced in revolutions as disclosed in Japanese Laid-open Patent Application 2010-117421, it is possible that the amount by which air is exhausted from within the image forming apparatus will be insufficient to remove all the dust in the apparatus. Thus, it is possible that the internal space of the image forming apparatus will be filled with the dust. With the internal space of the image forming apparatus being filled with the dust, it is possible that the dust will adhere to various internal portions of the apparatus, eventually transferring onto a sheet of recording medium as the sheet is conveyed through the apparatus.

### SUMMARY OF THE INVENTION

Thus, the primary object of the present invention is to provide an image forming apparatus capable of reducing as much as possible the amount by which the dust transfers onto a sheet of recording medium.

According to an aspect of the present invention, there is provided an image forming apparatus comprising an image forming station configure to form a toner image on a recording material using toner containing a parting material; a fixing portion configured to heat-fix the toner image formed on the recording material by said image forming station; a fan configured and positioned to discharge air adjacent said fixing portion to an outside of said apparatus through a discharging path; a filter provided in said discharging path; and a controller capable of executing an operation in a first control mode in which a driving speed of said fan is changed in a set range in accordance with information corresponding to a temperature adjacent said image forming station which temperature rises with operation of the fixing portion, a second control mode in which the driving speed of said fan set at an upper limit speed in the set range irrespective of the information corresponding to the temperature adjacent said image forming station.

According to another aspect of the present invention, there is provided an image forming apparatus comprising an image forming station configure to form a toner image on a recording material using toner containing a parting material; a fixing portion configured to heat-fix the toner image formed on the recording material by said image forming station; a fan configured and positioned to discharge air adjacent said fixing portion to an outside of said apparatus through a discharging path; a filter provided in said discharging path; and a controller configured to control said fan in which a driving speed of said fan when an image formation is carried out on a predetermined number of recording materials before a predetermined time elapses from completion of a last image formation job is higher that when the image formation is carried out on the predetermined number of recording materials before the predetermined time elapses from completion of the last image formation job.

According to a further aspect of the present invention, there is provided an image forming apparatus comprising an image forming station configure to form a toner image on a recording material using toner containing a parting material; a fixing portion configured to heat-fix the toner image formed on the recording material by said image forming station; a fan configured and positioned to discharge air adjacent said fixing portion to an outside of said apparatus through a discharging path; a filter provided in said discharging path; a temperature sensor configured and positioned to detect a temperature adjacent an entrance of the recording material to said fixing portion; and a controller configured to control said fan in which when an image formation job is carried out on a predetermined number of recording material, said fan is operated in which a driving speed of said fan in the case that a detected temperature of the temperature sensor upon start of the image formation job is not higher than a predetermined temperature is higher than in the case that the detected temperature is higher than the predetermined temperature.

Further features of the present invention will become apparent from the following description of exemplary embodiments (with reference to the attached drawings).

### BRIEF DESCRIPTION OF THE DRAWINGS

FIG. 1 is a schematic sectional view of the image forming apparatus in the first embodiment of the present invention, at a vertical plane parallel to the front surface of the apparatus, as seen from the front side of the apparatus.

FIG. 2(a) is a partially broken external perspective view of the image forming apparatus in the first embodiment, as seen from the front side, and shows the fixing device and air exhausting means in the apparatus. FIG. 2(b) is a partially broken external perspective view of the image forming apparatus in the first embodiment, as seen from the rear side, and shows the fixing device and air exhausting means in the apparatus.

FIG. 3 is a block diagram of the control system of the image forming apparatus in the first embodiment.

FIG. 4(a) is a partially broken perspective view of the fixing device and air exhausting means of the image forming apparatus in the first embodiment, and FIG. 4(b) is a partially broken perspective view of the fixing device and air exhausting means of the image forming apparatus in the first embodiment as seen from the different angle from the angle from which they are seen in FIG. 4(a).

FIG. 5 is an enlarged partially broken front view of the fixing device and air exhausting means of the image forming apparatus in the first embodiment.

FIG. 6 is a graph which shows the chronological changes in the amount of dust generation.

FIG. 7 is a drawing for showing the relationship between the changes in the developing apparatus temperature and the fan drive duty.

FIG. 8 is a flowchart of the control sequence in the first embodiment.

FIG. 9 is a flowchart of the control sequence in the second embodiment.

FIG. 10 is a sectional view of the fixing device, an air exhaust duct, and their adjacencies, at a plane parallel to the recording medium conveyance direction.

FIG. 11 is a flowchart of the control sequence in the third embodiment.

FIG. 12 is a schematic sectional view of one of the modified versions of the image forming apparatus in the first embodiment, and shows the general structure of the apparatus.

### DESCRIPTION OF THE PREFERRED EMBODIMENTS

Hereinafter, the embodiments of the present invention are described with reference to the appended drawings. However, the measurements, materials, and shapes of the structural components of the image forming apparatuses in the following embodiments, and the positional relationship among the structural components, are to be altered according to the structure of the apparatus to which the present invention is applied, and also, the conditions under which the apparatus is operated. That is, they are not intended to limit the present invention in scope.

### Embodiment 1

### <Image Formation Section>

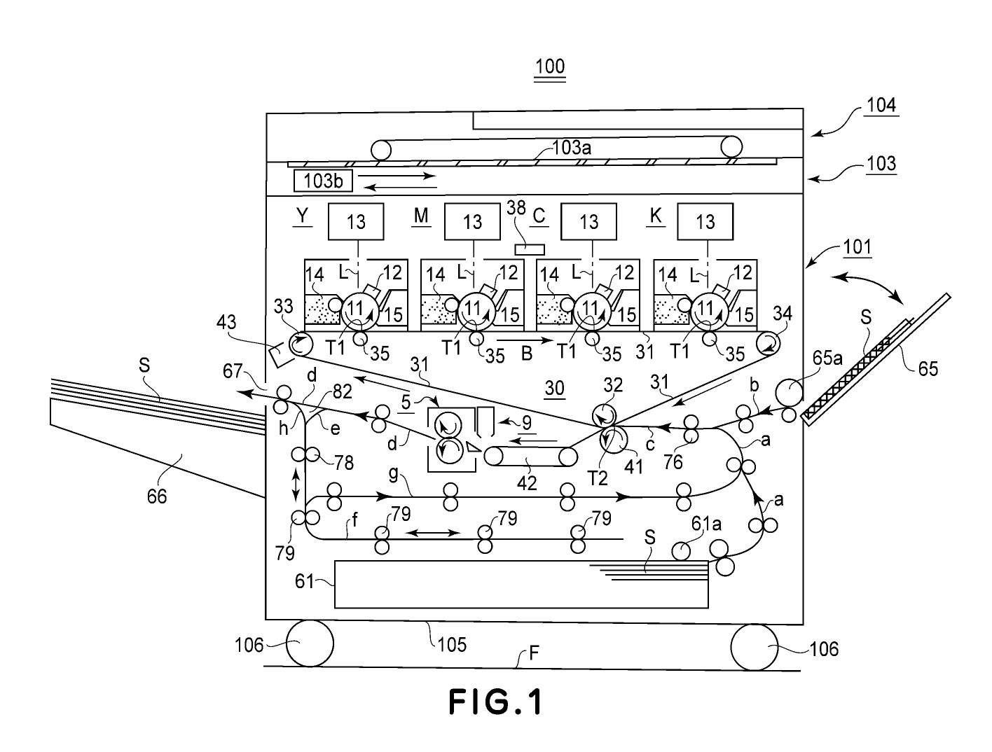

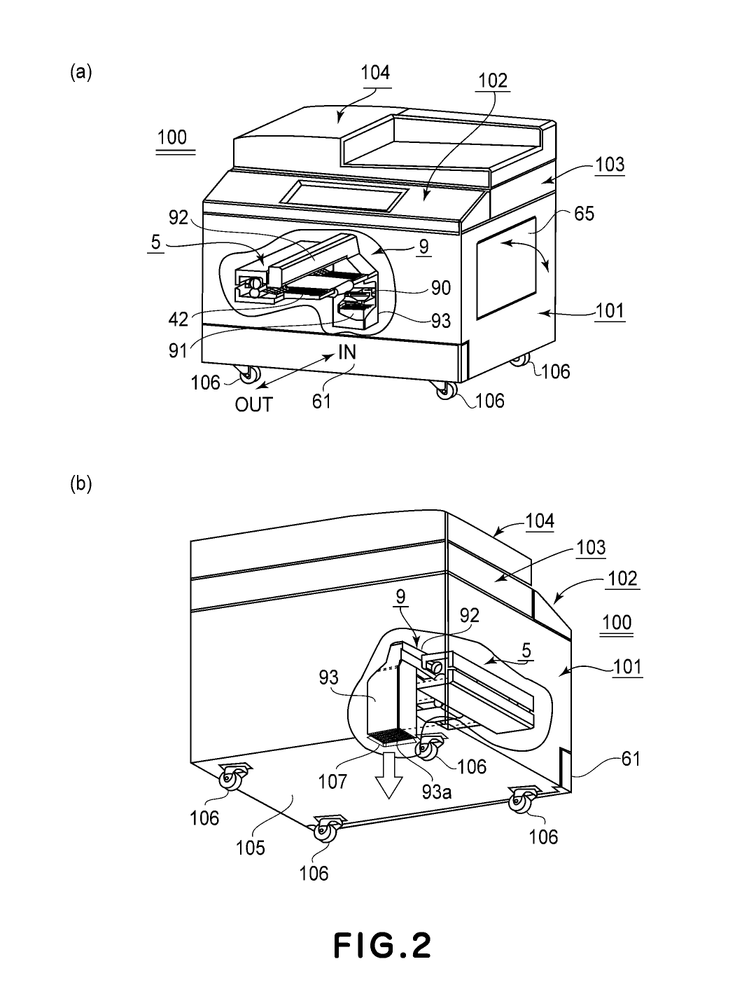

FIG. 1 is a sectional view of the image forming apparatus 100 in this embodiment, at a vertical plane parallel to the recording medium conveyance direction of the apparatus. FIG. 2(a) is a partially broken external perspective view of the apparatus 100 shown in FIG. 1, as seen from the front side of the apparatus 100. It shows the fixing device (fixing means) 5, air exhausting means 9, and their adjacencies, of the image forming apparatus 100. FIG. 2(b) is an external perspective view of the image forming apparatus 100 in the first embodiment, as seen from the rear side of the apparatus 100, a part of which is intentionally omitted to show the fixing device 5, air exhausting means 9, and their adjacencies, which are in the image forming apparatus 100.

Regarding the directional references of the image forming apparatus 100 in this embodiment, the front surface side (front side) of the apparatus 100 is the side of the apparatus 100, from which a sheet feeder/storage cassette 61 in which sheets S of recording medium are stored in layers, can be pulled out from within the image forming apparatus main assembly 101. The rear surface side (rear side) of the image forming apparatus 100 is the opposite side from the front side. The top (upward) and bottom (downward) directions are the directions parallel to the direction of gravity. The front-to-rear (rearward) direction and rear-to-front (frontward) direction are the directions perpendicular to the recording medium conveyance direction of the apparatus 100. Further, the left and right of the image forming apparatus 100 are the left and right of the apparatus as seen from the front side of the apparatus 100. The left-to-right direction and right-to-left direction of the image forming apparatus 100 are the left-to-right and right-to-left directions as seen from the front side of the apparatus 100.

The image forming apparatus 100 in this embodiment is a color image forming apparatus which uses an electrophotographic image forming method. In recent years, an image forming apparatus of the intermediary transfer/tandem type, in which four image formation sections, different in the color of the toner they use, are aligned in parallel along an intermediary transfer belt, has become a mainstream image forming apparatus. The image forming apparatus 100 in this embodiment is also of the intermediary transfer/tandem type.

Roughly stated, this image forming apparatus 100 has: the main assembly 101; a control panel placed on the top front side of the main assembly 100; an image reader section 103 placed on the rear side of the control panel 102; and an automatic original feeding device 104 placed above the image reader section 103.

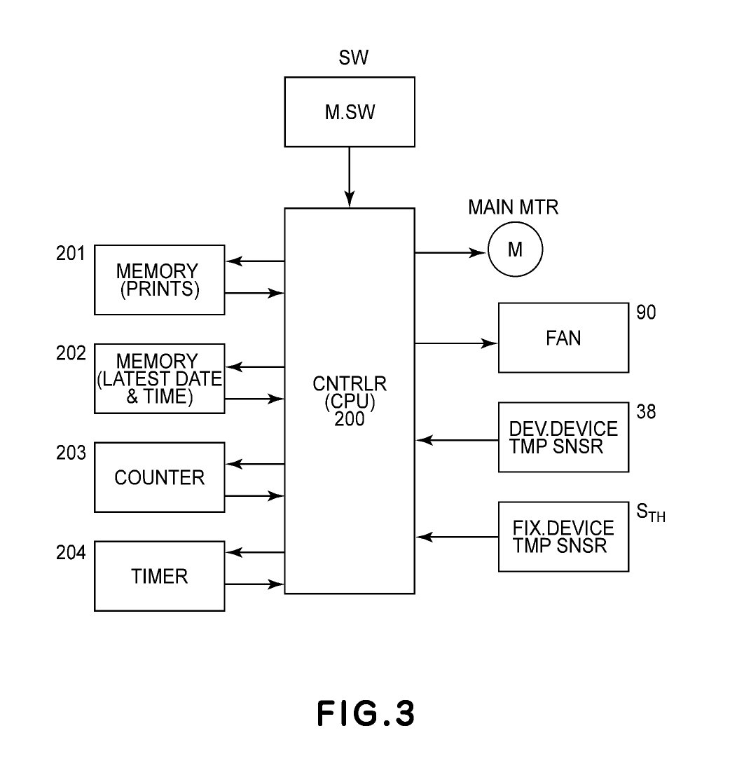

The top side of the control panel 102 is provided with operating means, such as a main switch for electric power, an information display panel, keys for inputting various information, etc. There is a control section (control substrate: CPU 200 (FIG. 3)) on the inward side of the control panel 102. The control section 200 integrally controls the image forming apparatus 100 according to preset control programs and referential tables.

The image reader section 103 reads an original placed on the original placement glass platen 103a of the image reader section 103 in such a manner that the image bearing surface of the original faces downward, with the use of its photoelectric unit 103b for separating the image of the original into monochromatic images of the primary color components, and inputting the information of the original into the image processing portion of the control section 200. The automatic original feeding/conveying device 104 is an RDF device or an ADF device, which automatically conveys an original onto the original placement glass platen 103a.

In the image forming apparatus main assembly 103, there are four image formation sections, more specifically, the first to fourth image formation sections Y, M, C and K, which are horizontally aligned in the left-to-right direction in FIG. 1. Each of the image formation sections Y, M, C and K is an electrophotographic processing system made up of an electrophotographic photosensitive member (which will be referred to as drum) 11 as an image bearing member, a charging device 12, an exposing device 13, a developing device 14, a primary transferring device 35, a photosensitive member cleaning device 15, etc. The drum 11 is rotationally driven in the counterclockwise direction indicated by an arrow mark, at a preset peripheral velocity (process speed). The developing device (developing portion) 14 develops an electrostatic image formed on the drum 11, with toner.

There is stored toner of yellow (Y) color, as developer, in the developing device 14 of the first image formation section Y, which forms a toner image of the yellow (Y) color, on the drum 11. There is stored toner of magenta (M) color, as developer, in the developing device 14 of the second image formation section M, which forms a toner image of the magenta (M) color, on the drum 11. There is stored toner of cyan (C) color, as developer, in the developing device 14 of the third image formation section C, which forms a toner image of the cyan (C) color, on the drum 11. Further, there is stored toner of black (K) color, as developer, in the developing device 14 of the fourth image formation section K, which forms a toner image of the black (K) color on the drum 11. Each of the four toners, different in color, contains wax as parting agent.

There is positioned an intermediary transfer belt unit 30 on the underside of the above-mentioned four image formation sections Y, M, C and K. The unit 30 has an endless belt 31, as an intermediary transfer belt, which is flexible and circularly movable. The belt 31 is suspended and kept stretched by three rollers, more specifically, a driver roller 33, which is the left roller, a steering roller 34, which is the right roller, and a secondary transfer roller 32, which is positioned lower than the two rollers 33 and 34, and between the two rollers 33 and 34 in terms of the recording medium conveyance direction.

The belt 31 is circularly moved in the clockwise direction indicated by an arrow mark B, which is such a direction that the direction in which the belt 31 moves in the interface between the drum 11 and belt 31 becomes the same as the direction in which the peripheral surface of the drum 11 moves in the interface. The steering roller 34 has the function of adjusting the thrust position of the belt 31 while the belt 31 is circularly moved.

In this embodiment, the primary transferring device 35 in each of the image formation sections Y, M, C and K is an electrically conductive roller (primary transfer roller), and is positioned on the inward side of the loop which the belt 31 forms. The primary transfer roller 35 in each image formation section is kept pressed upon the downwardly facing portion of the peripheral surface of the drum 11, with the presence of the portion of the belt 31, which corresponds to the top portion of the loop which the belt 31 forms, between the rollers 34 and 35. The area of contact between each drum 11 and the belt 31 is the primary transfer section (nip) T1. The rollers 32 and 34, and 35 are rotated by the movement of the belt 31 which is circularly moved by the driver roller 33.

Upon the secondary transfer roller 32 which is inside the abovementioned belt loop, the second transfer roller 41 which is outside the belt loop, is kept pressed, with the presence of the belt 30 between the two rollers 32 and 41. The area of contact between the belt 31 and secondary transfer roller 41 is the secondary transfer station (nip) T2. The secondary transfer roller 41, or the secondary transfer roller which is outside the belt loop, is rotationally driven in the counterclockwise direction indicated by an arrow mark, at roughly the same speed as the peripheral velocity of the belt 31. The second transfer outside roller 41 is supported so that it can be attached to, or removed from, the secondary transfer inside roller 32.

Below the unit 30, the sheet feeder cassette 61, as recording medium storage, which is in the form of a drawer, is positioned. In the sheet feeder cassette 61, sheets S of recording medium are stored in layers. The sheet feeder cassette 61 is of the front loading type. That is, it can be pulled out frontward from within the image forming apparatus main assembly 101 to be replenished with sheets S of recording medium. It can be pushed all the way into the image forming apparatus main assembly 101 in the opposite direction from the direction in which it can be pulled out of the image forming apparatus main assembly 101. As the sheet feeder cassette 61, in which sheets S of recording medium are present, is pushed all the way into the image forming apparatus main assembly 101, the image forming apparatus 100 becomes ready for an image forming operation.

The image forming apparatus main assembly 101 is provided with a manual sheet feeding tray (multi-paper tray) 65, as recording medium storage which is independent from the sheet feeder cassette 61. The manual sheet feeder tray 65 is attached to the outward side of the right wall of the image forming apparatus main assembly 101. This sheet feeder tray 65 can be folded flat on the right wall of the image forming apparatus main assembly 101 as shown in FIG. 2(a). It can be unfolded into the position in which it is held at a preset angle relative to the right wall, as shown in FIG. 1, when it is necessary for the tray 65 to be used, so that sheets S of recording medium can be mounted on the tray 65.

The operation to be carried out by the image forming apparatus 100 in this embodiment to form a full-color image is as follows: First, a user (operator) of the image forming apparatus 100 is to turn on the main power switch SW (FIG. 3). As the main power switch SW is turned on, the main motor (driving means) is started up, and the image forming apparatus 100 is put through a preset startup sequence. Then, the apparatus 100 is put on standby. It is when the image forming apparatus 100 is in this state of standby that the user is to place an original (originals) on the original placement glass platen 103a, or in the automatic original feeding/conveying device 104. Then, the user is to set image formation conditions with the use of the control panel 102, as necessary, and to press the copy button.

The control section 200 restarts the main motor, in response to the signal generated by the pressing of the copy bottom, and starts the image formation sequence. The image reader section 103 reads the original on the original placement glass platen 103a, with the use of its photoelectric image reading/color separating unit 103b, and inputs the information of the original, obtained by the image reader section 103, into the image processing portion of the control section 200. Further, drum 11 in each of the image formation sections Y, M, C and K is rotationally driven. Further, the belt 31 is circularly driven. The exposing device 13 also is driven. In synchronism with the driving of these components and devices, the charging device 12 in each of the image formation sections Y, M, C and K uniformly charges the peripheral surface of the corresponding drum 11, to preset polarity and potential level, with the preset control timing.

In this embodiment, the exposing device 13 is a laser scanner, which scans (exposes) the uniformly charged portion of the peripheral surface of the drum 11, with the beam L of laser light which it outputs while modulating the beam L with the information of the original (electrical data of original: signals which reflect information of original) obtained by the image reader section 103 which photoelectrically reads the original and separates the image of the original into monochromatic images of primary color components. Consequently, an electrostatic image (electrostatic latent image) which corresponds to the primary exposure pattern is formed on the peripheral surface of the drum 11. That is, four electrostatic images, which correspond one for one to the primary color components of the original, are formed on the peripheral surfaces of the photosensitive drums 11 in the image formation stations Y, M, C and K, respectively.

Then, each electrostatic image is developed into a toner image by the developing device 14 (developing portion). The developing method used in this embodiment is the so-called reversal developing method, which adheres toner, which contains parting agent (wax), to the exposed points (light potential level) of the peripheral surface of the drum 11.

Through an electrophotographic image formation process such as the one described above, a toner image of the yellow (Y) color, which corresponds to the yellow (Y) color component of the full-color image, is formed on the drum 11 of the first image formation section Y. This toner image is transferred (primary transfer) onto the belt 31, in the primary transfer station T1. On the drum 11 of the second image formation section M, a toner image of the magenta (M) color, which corresponds to the magenta (M) color component of the full-color image, is formed. This toner image is transferred (primary transfer) onto the belt 31, in the primary transfer station T1, in such a manner that it is layered on the toner image of the yellow (Y) color which has already been transferred onto the belt 31.

Further, on the drum 11 of the third image formation section C, a toner image of the cyan (C) color, which corresponds to the cyan (C) color component of the full-color image, is formed. This toner image is transferred onto the belt 13 in the primary transfer station T1, in such a manner that it is layered upon the yellow (Y) and magenta (M) toner images having already been transferred onto the belt 31. On the drum 11 of the fourth image formation station K, a toner image of the black (K) color, which corresponds to the black (K) color component of the full-color image, is transferred (primary transfer) onto the belt 31, in the primary transfer station T1, in such a manner that it is layered in the preset manner on the toner images of the yellow (Y), magenta (M) and cyan (C) colors.

In each of the image formation stations Y, M, C and K, the primary transfer of the toner image from the drum 11 onto the belt 31 is done by the application of the primary transfer voltage to the roller 35. That is, it is done by the application of the primary transfer voltage, which is opposite in polarity from the normal polarity to which the toner is chargeable, from the primary transfer power source (unshown) to the roller 35. More specifically, the primary transfer of the toner image onto the drum 11 onto the belt 31 is done by the combination of the electric field generated by this voltage applied to the primary transfer roller 35, and the pressure in the nip of the primary transfer station T1.

Consequently, an unfixed full-color toner image, is synthetically formed of the Y, M, C and K colors, on the belt 31. That is, the image formation processes for forming the Y, M, C and K toner images in the image formation sections Y, M, C and K, respectively, are carried out with such timings that the toner images formed in the downstream image formation sections are layered (primary transfer) on the toner images, on the belt 31, which are from the upstream image formation stations. As a result, a full-color toner image is formed on the belt 31. The toner remaining on the peripheral surface of the drum 11 in each of the image formation sections Y, M, C and K after the primary transfer of the toner image onto the belt 31, is removed by the photosensitive member cleaner 15.

Meanwhile, the sheet feeder roller 61a begins to be driven with a preset control timing. As the roller 61a is driven, the sheets S of recording medium in the sheet feeder cassette 61 are fed into the image forming apparatus main assembly 101 one by one while being separated from the rest in the cassette 61, and are conveyed to a pair of registration rollers 76 through the recording medium conveyance passage a. Or, as the sheet feeder roller 65a is driven with a preset control timing, the sheets S of recording medium on the manual sheet feeder tray 65 are fed into the image forming apparatus main assembly 101 one by one while being separated from the rest on the tray 65, and then, are conveyed one by one to the pair of registration rollers 76 through a sheet conveyance passage b.

As a sheet S of recording medium is conveyed to the pair of registration rollers 76 from the sheet feeder cassette 61 or manual sheet feeder tray 65, the pair of registration rollers 76 catches the sheet S by the nip which the two registration rollers 76 form between them, while remaining stationary, bending thereby each sheet S in curvature, so that if the sheet S is conveyed askew to the pair of registration rollers 76, the pair of registration rollers 76 can correct the sheet S in attitude by causing the leading edge of the sheet S to conform to the nip between the two rollers 76. That is, the pair of registration rollers 76 has the function of correcting the sheet S in attitude. It has also the function of conveying the sheet S to the secondary transfer station T2, with a preset timing with which an image (images) is formed on the sheet S, more specifically, such a timing that the toner image(s) on the belt 31 arrives at the secondary transfer station T2 as the same time as the sheet S.

The pair of registration rollers 76 begins to be rotationally driven with the preset timing after the correction in attitude of the sheet S, sending thereby the sheet S to the secondary transfer station T2 through the sheet conveyance passage c. That is, the sheet S is released (sent forward) by the pair of registration rollers 76 with such a timing that the leading edge of the toner image formed on the belt 31, arrives at the secondary transfer station T2 at the same time as the leading edge of the sheet S. Then, as the toner images on the belt 31 are conveyed through the secondary transfer station T2 while remaining pinched between the belt 31 and sheet S, they are transferred together (secondary transfer) onto the surface of the sheet S as if they are peeled away from the belt 31.

In order to transfer (secondary transfer) the toner images from the belt 31 onto the sheet S, a preset secondary transfer voltage, which is opposite in polarity to the normal polarity to which the toner is chargeable, and the potential of which is at a preset level, is applied to the secondary transfer outside roller 41 from the secondary transfer power source (unshown). It is by the combination of this voltage applied to the secondary transfer outside roller 41, and the nip pressure of the secondary transfer station T2 that the toner images on the belt 31 are transferred onto the sheet S.

In this embodiment, each of the above-described image formation stations is the means for forming a toner image (images) on the sheet S of recording medium, with the use of toner which contains parting agent. After being conveyed through the secondary transfer station T2, the sheet S is separated from the surface of the belt 31, and is conveyed by a sheet conveying device 42 of the suction type, to the fixing device (fixing section; image heating section for heating toner image on sheet S) 5. The sheet conveying device 42 of the suction type conveys the sheet S while keeping the sheet S adhered to itself by creating vacuum between the sheet S and device 42 by suctioning away the air between the sheet S and itself with the use of a fan or the like. After the separation of the sheet S from the belt 31, the contaminants such as the residual toner, paper dust, etc., on the surface of the belt 31 are made, by the movement of the subsequent movement of the belt 31, to reach the belt cleaner 43, by which they are removed from the surface of the belt 31.

The fixing device 5 is the fixing means which thermally fixes the toner image formed on the sheet S of recording medium by the above described image forming means, to the sheet S. The fixing device 5 applies the combination of the preset amount of pressure (nip pressure) between its pair of opposing rollers, belts, etc., and the heat from its heat source (heating portion), such as a heater, to permanently weld (fix) the toner images to the sheet S. When the image forming apparatus 100 is in the one-sided image formation mode, the sheet S, which is bearing a toner image fixed thereto through the above described process, is conveyed through the sheet conveyance passage d, and is discharged onto an external delivery tray 66 through a sheet discharge opening 67.

In a case where the image forming apparatus 100 is in the two-sided image formation mode, as the sheet S, which is bearing a fixed toner image on one of its two surfaces, is conveyed out of the fixing device 5, it is changed in course from the normal passage to the reversal guidance passage e by the flag 82, and is pulled into the switch-back passage f. As the sheet S is pulled into the switch-back passage f, a pair of sheet reversing rollers 79 is reversed in its rotational direction (switch-back operation). Thus, the sheet S is conveyed into the two-sided image formation passage g, so that the edge of the sheet S, which was the trailing edge of the sheet S when it was conveyed so that an image is formed on its first surface, becomes the leading edge.

After the sheet S is conveyed to the two-sided image formation conveyance passage g, it is conveyed back into the sheet conveyance passage a in such a timing that it does not interfere with the sheet S of recording medium conveyed into the passage a from the sheet feeder cassette 61 or manual sheet feeder tray 56 for the following job. Then, it is reintroduced into the secondary transfer station T2 by way of the pair of registration rollers 76. Then, a toner image is transferred (secondary transfer) onto the second surface of the sheet S. After being conveyed out of the secondary transfer station T2, the sheet S is reintroduced into the fixing device 5 by the sheet conveying device 42 of the suction type, is conveyed through the sheet passage d and sheet discharge opening 67, and is discharged as a two-sided print onto the delivery tray 66.

In a case where the mode for discharging a sheet of recording medium onto the delivery tray 66 in such a manner that the surface of the sheet S, which has been facing upward in the image forming apparatus 100, faces downward, has been selected while the image forming apparatus 100 is in the one-sided or two-sided image formation mode, as the sheet S is conveyed out of the fixing device 5 after an image was formed on one or both surfaces of the sheet S, the sheet S is changed in course by the flag 82 toward the reversal guidance passage e. Then, the sheet S is pulled into the switch-back passage f. As the sheet S is pulled into the switch-back passage f by a preset distance, the pair A of reversal rollers 78 and the pair B of reversal rollers 79 are reversed in their rotational direction (switch-back operation). Thus, the sheet S is conveyed into the sheet conveyance passage h in such an attitude that the edge of the sheet S, which was the trailing edge until the sheet S was reversed in the conveyance direction, becomes the leading edge. Then, it is discharged onto the delivery tray 66 through the sheet discharge opening 67.

After an image forming operation such as the one described above is carried out for a preset number (single or multiple) of sheets S of recording medium, the image forming operation by the image forming apparatus 100 is ended. As for the fixing device 5, as the image forming operation by the image forming apparatus 100 ends, the fixing device 5 is put in the standby mode, in which electric power is not supplied to the heating means of the fixing device 5.

Referring to FIGS. 1 and 2, a referential code 105 stands for the bottom plate of the image forming apparatus main assembly 101, and a referential code 106 stands for a caster attached to the four corners of the bottom plate 105. A referential code F stands for a floor (surface) on which the image forming apparatus 100 is positioned.

### <Control of Exhaust Fan>

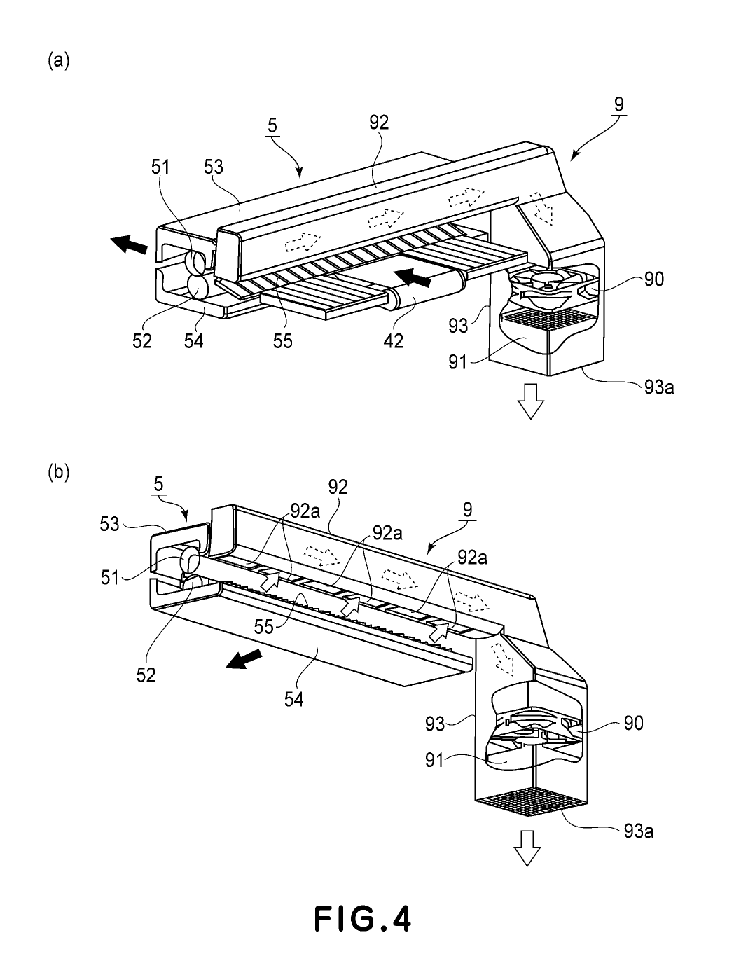

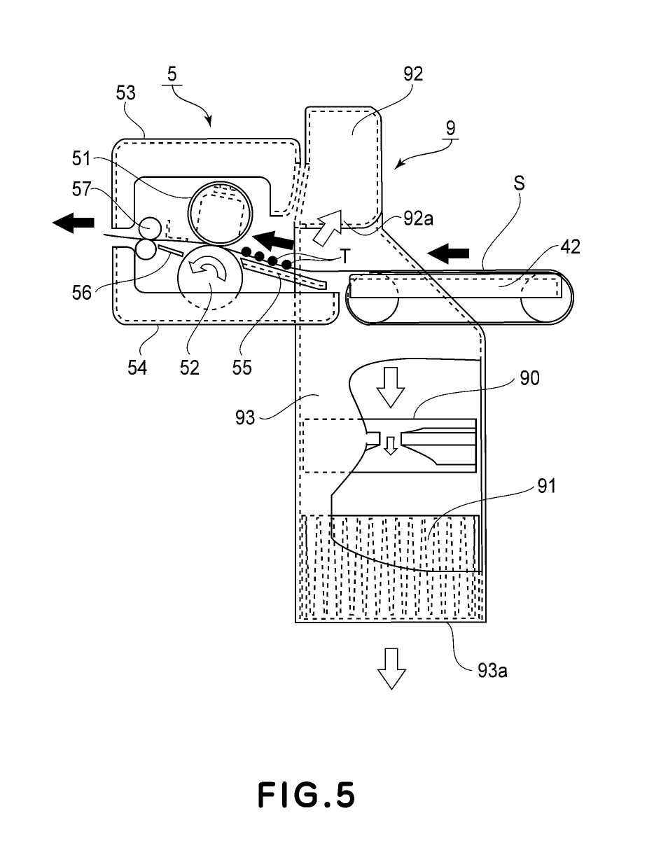

Referring to FIGS. 1 and 2, there is positioned in the image forming apparatus main assembly 101, an air exhausting system 9 which suctions the air in the adjacencies of the fixing device 5, and exhausts the suctioned air out of the image forming apparatus main assembly 101. FIG. 4(a) is a partially broken perspective view of the fixing device and exhaust system 9, and FIG. 4(b) is a partially broken perspective view of the fixing device 5 and exhaust system, which is different in the angle of view from FIG. 4(a). FIG. 5 is an enlarged and partially broken front view of the fixing device 5 and exhaust system 9.

The fixing device 5 is positioned in the image forming apparatus main assembly 101 in such an attitude that its lengthwise direction is parallel to the front-to-rear direction of the image forming apparatus main assembly 101. It has a rotational fixing member (heating member) 51, as the top rotating member, and a rotational pressure applying member (pressure applying member) 52, as the bottom rotating member. The two rollers 51 and 52 are pressed upon each other, forming thereby the fixation nip between the two. The fixing device 5 has also the top frame 53 and bottom frame 54, which envelop the rotational fixing member 51 and rotational pressure applying member 52. There is positioned a recording medium introduction guide 55 at the recording medium entrance side of the gap between the top and bottom frames 53 and 54. Further, there is positioned a recording medium discharge guide 56 and a recording medium discharge roller 57 at the recording medium exit side of the gap between the top and bottom frames 53 and 54.

The rotational fixing member 51 and rotational pressure applying member 53 are rotationally driven in the recording medium conveyance direction at a preset peripheral velocity. The temperature of the rotational fixing member 51 is increased to a preset fixation level, and kept at the fixation level, by supplying the heat source (heating means) with electric power. While the temperature of the rotational fixing member 51 is kept at the fixation level, the sheet S of recording medium on which an unfixed toner image (images) is borne is conveyed by the sheet conveying device 42 of the suction type to the fixing device 5 from the image formation station side. Then, the sheet S is introduced into the fixing device 5 through the recording medium entrance between the top and bottom frames 53 and 54. Then, the sheet S is made to enter the fixation nip, which is the area of contact between rotational fixing member 51 and rotational pressure applying member 52, and is conveyed through the fixation nip, while being guided by the recording medium guide 55. Consequently, the unfixed toner image T is thermally fixed, as a permanent image, to the surface of the sheet S.

After being conveyed out of the fixation nip, the sheet S of recording medium is separated from the rotational fixing member 51, and is conveyed further, while being guided by the recording medium guide 56, through the nip between the pair of discharge rollers 57. Then, it is sent out of the fixing device 5 through the recording medium exit which is between the top and bottom frames 53 and 54.

The exhaust system 9, which draws the air in the adjacencies of the fixing device 5 and exhausts the drawn air out of the image forming apparatus 100, has a horizontal air duct 92, which is positioned at the recording medium entrance side (upstream side of fixation nip in terms of recording medium conveyance direction) of the top frame 53 of the fixing device 5, and which extends in the lengthwise direction of the fixing device 5. The exhaust system 9 has also a vertical duct 93. The horizontal duct 92 and vertical duct 93 are in connection to each other.

The bottom side of the horizontal duct 92 is provided with multiple intake openings 92a, which are aligned in the lengthwise direction of the ducts 92. The vertical duct 93 extends downward from the horizontal duct 92 so that its bottom ends reaches the bottom plate 105 of the image forming apparatus main assembly 101. Thus, the bottom opening 93a of the vertical duct 93 is next to the exhaust opening with which the bottom plate 105 is provided. Further, the vertical duct 93 is provided with a fixation exhaust fan 90, which is positioned in the mid portion of the duct 93. Further, the vertical duct 93 is provided with a filter 91, which is positioned within the duct 92, on the opening 93a side of the internal fan 90. The filter 91 is positioned in the air passage of the above described exhaust system 9. It is a means for capturing the dust.

As the fan 90 is driven, the air in the adjacencies of the recording medium entrance of the fixing device 5 is drawn into the horizontal duct 92 through the air intake openings 92a, and then, is drawn into the vertical duct 93. Thus, an air flow is created, which is flowed through the fan 90 and filter 91 in the vertical duct 93, and then, is exhausted out of the image forming apparatus main assembly 101 (into space between bottom plate 105 and floor F) through the openings 93a and 107. Referring to FIGS. 4 and 5, the black arrow marks indicate the direction in which the sheet S of recording medium is conveyed. The white arrow marks drawn with solid lines indicate the direction of the exhaust air flow in the adjacencies of the fixing device 5. The white arrow marks drawn with dotted lines indicate the direction of the air flow within the ducts.

As described above, the exhaust system 9 has the fan 90 which exhausts the air in the adjacencies of the fixing device 5, through the ducts (air passages) 92 and 93, and the filter 91 positioned in the combination of the air ducts 92 and 93. That is, not only does the exhaust system 9 recover the dust which is possibly generated in the adjacencies of the fixing device 5 during the toner image fixation, with the use of its filter 91, but also, it removes the heat generated by the fixing device 5 to prevent the image forming sections (in particular, developing devices which are susceptible to temperature) from increasing in temperature. That is, the warm air which is present on the upstream side of the fixation nip of the fixing device 5 is drawn into the duct 92, and is exhausted out of the image forming apparatus 100 after the dust in the air is recovered by the filter 91.

As described above, the “dust” means the particles which are no more than 0.1 μm in size. According to the studies made by the inventors of the present invention, it is reasonable to think that the dust is the mist which results as the parting agent (wax) in the toner particles vaporizes during the fixation, and then, solidifies in the form of minute particles as it cools down.

Some conventional image forming apparatuses used in a business office for a printing operation of light duty, or outputting a large number of prints, which require a high level of productivity and image quality, require a very large amount of heat to fix the toner on a sheet of recording paper in a short time. Thus, in a case where the fixing device 5 and image forming apparatus main assembly 101 of such image forming apparatuses are started up from the state in which they have completely cooled down, for example, in a case where the main switch of the image forming apparatus 100 is turned on for the first time in the morning, the fixing device 5 has to be warmed up until its temperature increases to a preset level. Thus, it is usual that it takes roughly six minutes for a conventional image forming apparatus to become ready for a printing operation (to reach state of standby).

In recent years, however, fixing devices (5) employ a heater (heating section) based on IH (induction heating method), which is excellent in thermal efficiency. Thus, they start up very quickly. With the employment of this type of fixing device, the recent image forming apparatuses start up very quickly. Thus, high speed image forming apparatuses have been developed, which employ a fixing apparatus of the IH type, and therefore, it require only 30 seconds or so for them to become ready for image formation (to be put on standby) after their main power switch is turned on.

In a case where the image forming apparatus 100 is started up for the first time in the morning, that is, when it had completely cooled down, it is obvious that the fixing device 5 in the image forming apparatus 100, and the adjacencies of the fixing device 5 have also cooled down. Thus, after the main power switch is turned on, the heater of the fixing device 5 is operated at its maximum level of output to increase the temperature of the rotational fixing member 51 to the preset level for a printing operation as quickly as possible, until the apparatus 100 becomes ready for the first print. In this situation, therefore, the amount by which the dust is generated as the parting agent contained in the toner particles is made to evaporate into the adjacencies of the fixing device 5 by the heat generated to thermally fix the toner image is substantially greater than the amount by which the dust is generated after the temperature of the fixing device 5, the temperature of the adjacencies of the fixing device 5, and also, the internal temperature of the image forming apparatus 100 have been increased by the printing operation.

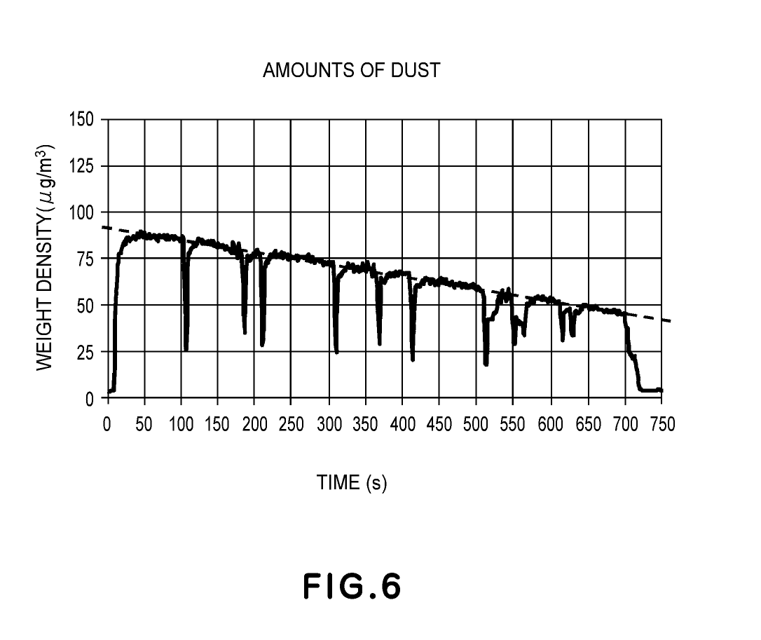

FIG. 6 is a graph which shows the chronological changes which occur to the amount of dust generation by the continuous printing operation started immediately after the cold image forming apparatus 100 was started up. It is evident from this graph that the amount of dust generation is largest right after the start of the printing operation, and gradually reduces as the printing operation continues.

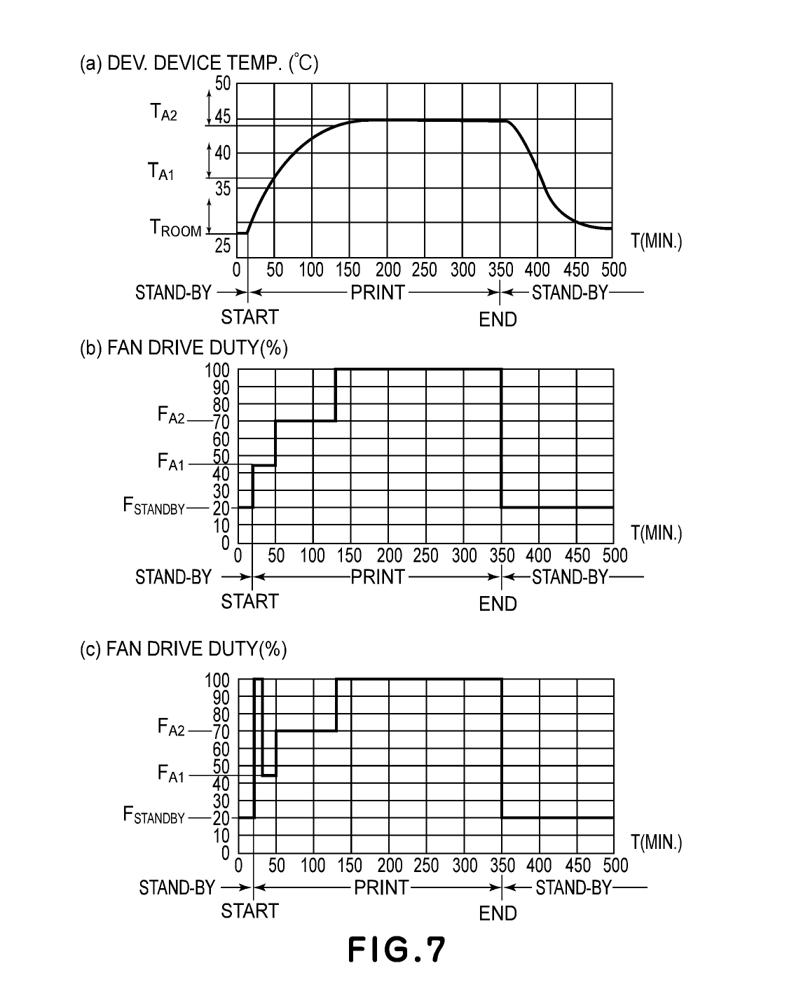

On the other hand, regarding the other objective of the exhaustion of the air in the adjacencies of the fixing device 5, that is, the objective of removing the heat in the adjacencies of the fixing device 5 out of the image forming apparatus 100, FIG. 7(a) shows the changes in the output of the developing device temperature sensor (temperature detecting means) 38, which occur during a printing operation. This sensor 38 is positioned in the adjacencies of the developing device 14. In order to maintain image quality, the temperature of the developing device 14 has to be kept below a preset level. Therefore, it is common practice to control the exhaust fan 90 in such a manner that as the temperature of the developing device 14 increases, the exhaust fan 90 is increased in steps in drive duty, as shown in FIG. 7(b). According to the exhaust fan control specification shown in FIG. 7(b), the exhaust fan 90 is controlled as follows:

| | |
|---|---|
| When on standby | drive duty: 20% |
| developing device temperature (-T_{A1}) | drive duty: 45% |
| developing device temperature (T_{A1}-T_{A2}) | drive duty: 70% |
| developing device temperature (T_{A21}-) | drive duty: 100% (maximum). |

However, as described above, the amount of dust generation is largest immediately after a printing operation is started when the image forming apparatus 100 has completely cooled down. Therefore, in the case of the above described heat removal control, the fan drive duty is lowest (fan revolution is lowest) immediately after the starting of a printing operation. Therefore, it is possible in some cases that the air flow which is generated as the air in the adjacencies of the fixing device 5 is drawn into the ducts 92 and 93 by the exhaust fan 90 is not sufficient to recover all the dust generated by a substantial amount immediately after the starting of the printing operation, making it possible for the image forming apparatus main assembly 101 to be filled with the dust. With the image forming apparatus main assembly 101 being filled with the dust, it is possible that while a sheet S of recording medium is conveyed through the image forming apparatus main assembly 101 during an image forming operation, the dust (wax) will transfer onto the sheet S, reducing thereby image quality. Therefore, in this embodiment, the image forming apparatus 100 is structured so that under the condition such as the above described one, the generated dust is satisfactorily captured by the filter 91 to prevent the dust from filling up the interior of the apparatus 100.

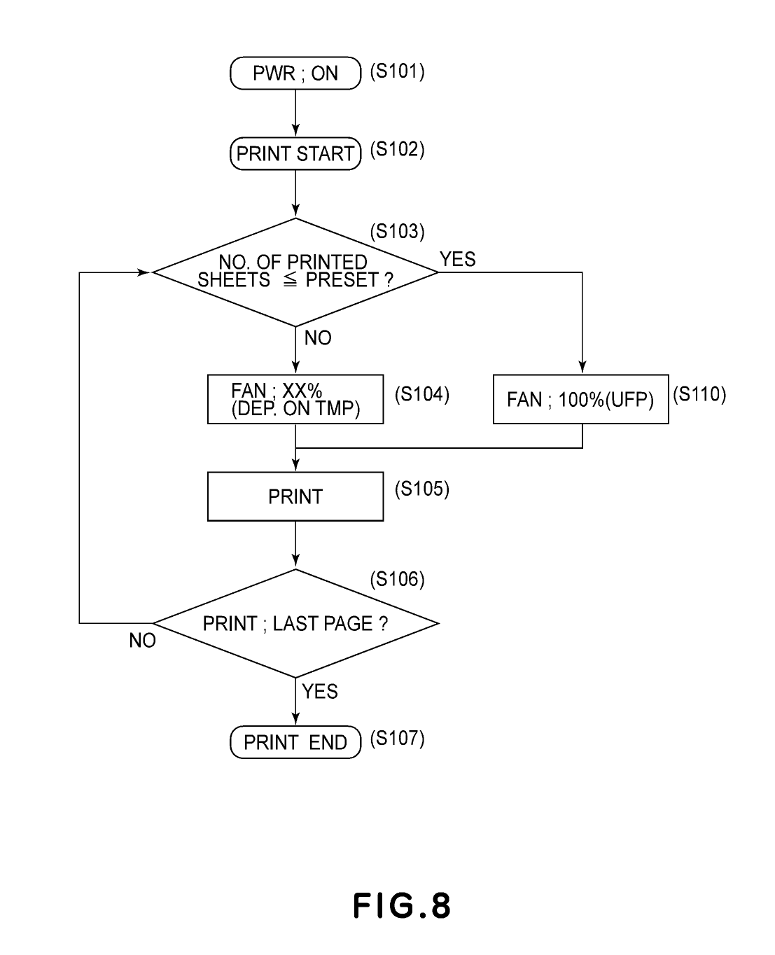

In this embodiment, therefore, a fan control such as the one shown in Figure (c) is carried out. Next, the fan control is described in detail with reference to the block diagram of the fan control in FIG. 3, and the flowchart of the fan control in FIG. 8.

Referring to the block diagram for the fan control, a referential code 201 stands for a memory (storage) for storing the print count. A referential code 202 stands for a memory (storage) for storing the date and time when the image forming apparatus 100 was used the last time (date and time when last printing job was ended). A referential code 203 stands for a counter (for counting number of prints outputted) which counts the number by which prints were continuously outputted. A referential code 204 stands for a timer (for measuring length of time) for measuring the length of the time which elapsed since the ending of the last printing job.

As the main power switch SW (FIG. 3) of the image forming apparatus 100 is turned on by a user (S101: electric power source is turned on), the main motor M is started up. Then, the apparatus 100 is put on standby after it is put through a preset initializing operation.

It is when the image forming apparatus 100 is in the above described state that the user is to place an original on the original placement glass platen 103a, or in the automatic original feeding/conveying device 104. Then, the user is to set image formation conditions, as necessary, with the use of the control panel 102, and press the copy button of the apparatus 100. Then, the control section 200 restarts up the main motor M in response to the signal generated by the pressing of the copy button, and starts controlling the image formation sequence (S102: PRINTSTART).

Then, the control section 200 looks up the value in the counter 203 to determine whether or not the number, by which prints were outputted since the main power switch SW was turned on the last time, has reached a preset value (preset value at which fixing device 5 will have warmed up enough for the amount of dust generation become equal to the amount of dust generation during the normal printing operation. If the print count has not reached the preset value, the control section 200 determines that the temperature of the image forming apparatus 100 is still below the normal fixation level. Then, it takes a measure for dealing with the situation in which the amount of dust generation is relatively large; it drives the exhaust fan 90 with the drive duty set to 100% (maximum drive speed) (S110).

Then, the control section 200 carries out the printing operation while driving the exhaust fan 90 at the maximum speed. Then, it determines whether or not the print being made is the last one in the current printing operation (S106). If the print is not the last one, the control section 200 goes back to the step S103, and checks the value in the counter 203.

If the control section 200 determines that the print count is greater than the preset value, it determines that the fixing device 5 has warmed up enough for the amount of dust generation to be normal. Thus, it sets the drive duty for the exhaust fan 90 to a value which corresponds to the output of the developing device temperature sensor 38, and continues the on-going printing operation (S105). If the control section 200 determines that the print being made is the last one, in step S106, it ends the printing operation (S107: PRINTEND).

In other words, in this embodiment, the fan drive duty is changed as shown in FIG. 7(c). That is, until a preset number of prints are printed after a printing operation is started, the fan drive duty is kept at 100% to ensure that the large amount of the dust, which is generated during this period is fully recovered by the filter 91.

Regarding the control of the fan 90 in this embodiment, the fan 90 can be operated in the first control mode in which the speed at which the fan 90 is driven is varied, within a preset range, according to the information about the temperature in the adjacencies of the image formation station, which increases as the fixing means 5 is operated. Further, it can be also operated in the second control mode in which the speed at which the fan 90 is driven becomes the maximum speed, within the preset range, regardless of the information about the ambient temperature of the image formation station. The control section 200 is the means for operating the fan 90 in the first or second control mode.

In the case of the first job to be carried out after the main power switch SW is turned on, the control section 200 controls the fan 90 in the second control mode. That is, in the case of the first job of the day, the control section 200 drives the fan 90 at the maximum speed.

In a case where the first image forming job carried out immediately after the main power switch SW is turned on is such a job that requires images are continuously formed on multiple sheets of recording medium, the control section 200 operates the fan 90 in the second control mode until images are formed on a preset number of sheets of recording medium. That is, in the case of the first job of the day, the control section 200 drives the fan 90 at the maximum speed until images are formed on the preset number of sheets of recording medium.

In a case where the first job of the day is such a job that requires images to be continuously formed on multiple sheets of recording medium one for one, the control section 200 operates the fan 90 in the second control mode until a preset length of time elapses. Thereafter, it operates the fan 90 in the first control mode. That is, in the case of the first job of the day, the control section 200 drives the fan 90 at the maximum speed until a preset length of time elapses.

If a point in time at which an image forming operation begins to be carried out is after the elapse of no less than a preset length of time since the completion of the last image formation job, the control section 200 operates the fixing device 5 in the second control mode. That is, in a case where an image formation job is carried out after the image forming apparatus 100 is kept on standby for a substantial length of time, the control section 200 drives the fan 90 at the maximum speed.

Further, in a case where the next job is such a job that continuously forms images on multiple sheets of recording medium one for one, the control section 200 operates the fixing device 5 in the second control mode until the image formation on a preset number of sheets of recording medium is completed, and then, operates the fixing device 5 in the first control mode for the rest of the image forming operation. That is, in the case of an image formation job for continuously forming images on multiple sheets of recording medium after the image forming apparatus 100 was kept on standby for a substantial length of time, the control section 200 drives the fan 90 at the maximum speed until the image formation on the preset number of sheets of recording medium is completed.

Also in a case where the next image formation job is such a job that continuously forms images on multiple sheets of recording medium one for one, the control section 200 operates the fixing device 5 in the second control mode until a preset length of time elapses, and then, operates the fixing device 5 in the first control mode for the rest of the image forming operation. That is, in the case of an image formation job for continuously forming images on multiple sheets of recording medium after the image forming apparatus 100 is kept on standby for a substantial length of time, the control section 200 drives the fan 90 at the maximum speed until a present length of time elapses.

The image forming apparatus 100 has the temperature sensor 38 for detecting the temperature of the adjacencies of the image forming means. In the first control mode, the control section 200 varies, within a preset range, the speed at which the fan 90 is driven, in response to the output of the temperature sensor 38. That is, in the normal mode, the control section 200 controls the fan 90 in response to the temperature. The temperature detection means 38 is positioned in the adjacencies of the development section. That is, the temperature of the developing device is the trigger for the fan control.

The image forming apparatus 100 has the counter 203 for counting the number of the prints which have been continuously outputted, as the information which is equivalent to the temperature of the adjacencies of the image formation section. In the first control mode, the control section 200 varies, within a preset range, the speed at which the fan 90 is driven, in response to the output of the counter 203. That is, in the normal mode, the control section 200 controls the fan 90 in response to the number of the completed prints in a given job.

The image forming apparatus 100 has the timer 204 for measuring the length of time images are continuously formed, as the information which is equivalent to the temperature of the adjacencies of the image formation section. In the first control mode, the control section 200 varies, within a preset range, the speed at which the fan 90 is driven, in response to the output of the timer 203. That is, in the normal mode, the control section 200 controls the fan 90 in response to the length of time which has elapsed since the starting of a given job.

According to this embodiment described above, it is possible to reduce the amount by which the dust, which originates from the parting agent contained in toner, is discharged from the image forming apparatus. Further, not only is it possible, in the first control mode, to prevent the adjacencies of the image formation section from excessively increasing in temperature, but also, it is possible in the second control mode to prevent the problem that the dust which originates from the parting agent contained in toner, fills up the internal space of the image forming apparatus, which in turn reduces the image forming apparatus in image quality. It is also possible to reduce the amount by which the dust is unintentionally allowed to leak from the image forming apparatus through the gaps or the like of the apparatus.

### Embodiment 2

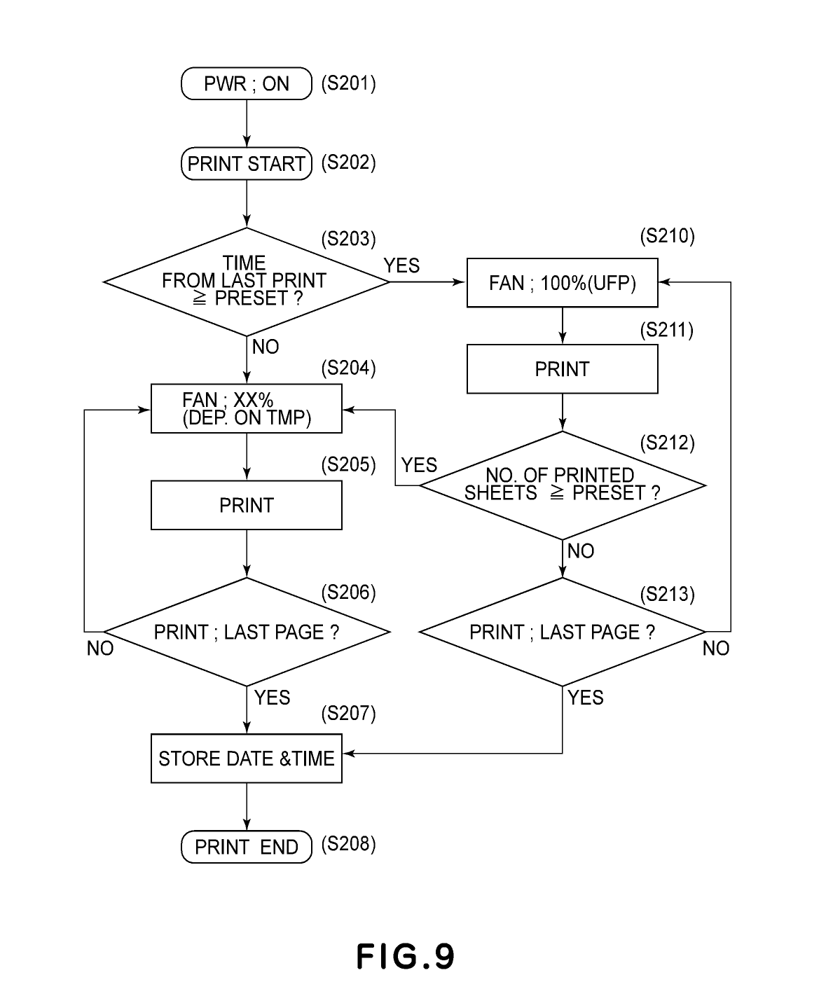

In this second embodiment of the present invention, the image forming apparatus is provided with a memory (storage) 202 for storing the date and time when the image forming apparatus was used the last time for image formation, as shown a part of the block diagram for the fan control. FIG. 9 is the flowchart for the fan control in the second embodiment of the present invention.

Referring to FIG. 9, steps S201 and S202 are the same as steps and S102 of the flowchart in FIG. 8. In the step S203, the control section 200 looks up the date and time when a print was outputted the last time (image forming job was carried out the last time), stored in the memory 202 (FIG. 3). Then, it determines whether or not the current date and time is no less than a preset length of time (long enough for the interior of the image forming apparatus main assembly 101 to sufficiently cool down) past the date and time in the memory (S203).

If no less than the preset length of time has elapsed, the control section 200 determines that the image forming apparatus 100 has sufficiently cooled. Then, it drives the fan 90 with the drive duty for the exhaust fan 90 set to 100% (maximum diving speed), in order to deal with the condition in which the amount of dust generation is large. Then, the control section 200 makes the image forming apparatus 100 perform a printing operation while driving the exhaust fan 90 at the maximum speed (S211).

Then, the control section 200 looks up the print count in the counter 201. If the print count has not reached the preset value (which is large enough for the fixing device 5 to be warmed up enough for the amount of dust generation to become the same as the amount of dust generation during the normal printing operation) (No in S212), the control section 200 determines whether or not the print is the last one to be printed in the current image forming operation (S213). If the print is not the last one to be printed, the control section 200 goes back to the step S210, and repeats the sequence from the step S210 to the step S213 until the print count obtained in the step S212 exceeds the preset value.

If the control section 200 determines in the step S213 that the print is the last one, before the print count obtained in the step S212 exceeds the preset value, it stores the date and time when the last print was printed, in the memory 205 (S207), and ends the printing operation (S208: PRINTEND).

If the control section 200 determines in the step S203 that no less than the preset length of time has not elapsed, and also, if the control section 200 determines in the step S212 that the print count has exceeded the preset value, the control section 200 moves to the step S204. That is, the control section 200 determines that the fixing device 5 has warmed up enough for the amount of dust generation to become normal. Then, it sets the drive duty for the exhaust fan 90 to a value which corresponds to the output of the developing device temperature sensor 38, and continues the printing operation (S205). Then, if it determines in the step S206 that the print is the last one, it stores the date and time when the last print was printed (S207), and ends the printing operation (S208: PRINTEND).

Regarding the control of the fan 90 in the second embodiment, in a case where images are formed on no less than a preset number of sheets of recording medium when the length of time which has elapsed since the end of the last image formation job is greater than a preset value, the control section 200 controls the fan 90 as follows. That is, it controls the fan 90 in such a manner that the speed at which the fan 90 is driven becomes greater than the speed at which the fan 90 is driven in a case where images are formed on a preset number of sheets of recording medium when the elapsed length of time is no more than the preset length of time.

The image forming apparatus 100 has the storage 202 for storing the date and time when the last job ended. The control section 200 calculates the above described elapsed length of time, with reference to the date and time stored in the storage 202, and controls the fan 90 according to the calculated length of time.

The image forming apparatus 100 has the timer 204 for measuring the length of time which elapsed since the end of the last image formation job. The control section 200 controls the fan 90 according the length of time measured by the timer 204.

The data and time when the last print is printed in the last image forming operation is stored in the memory 202. Therefore, if the image forming apparatus 100 is repeatedly turned on and off in a short length of time, the fixing device 5 and the internal space of the image forming apparatus main assembly 101 do not sufficiently cool down. Therefore, it is unnecessary to increase the drive duty for the fan 90. Therefore, it is possible to prevent electric power from being wastefully consumed, and also, to prevent the noise attributable to the fan 90 from unnecessarily increasing.

As described above, according to the second embodiment of the present invention, it is possible to prevent the problem that the dust which originates from the parting agent contained in toner fills up the internal space of the main assembly of an image forming apparatus, which in turn reduces the image forming apparatus in image quality. It is also possible to reduce the amount by which the dust is unintentionally allowed to leak out of the image forming apparatus through the gaps or the like which the apparatus has. Further, in a case where images are formed on a preset number of sheets of recording medium when the length of time which elapsed since the end of the last image formation job is no more than a preset length of time, it is possible to minimize the noise attributable to the increase in the speed at which the fan is driven, and also, it is possible to minimize the amount of electric power necessary to drive the fan.

### Embodiment 3

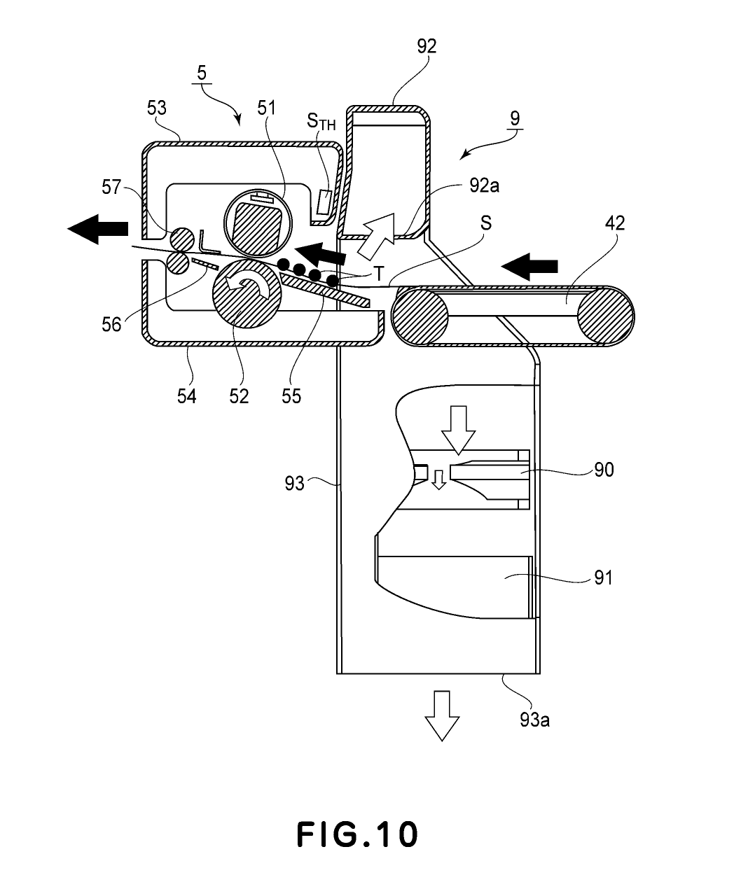

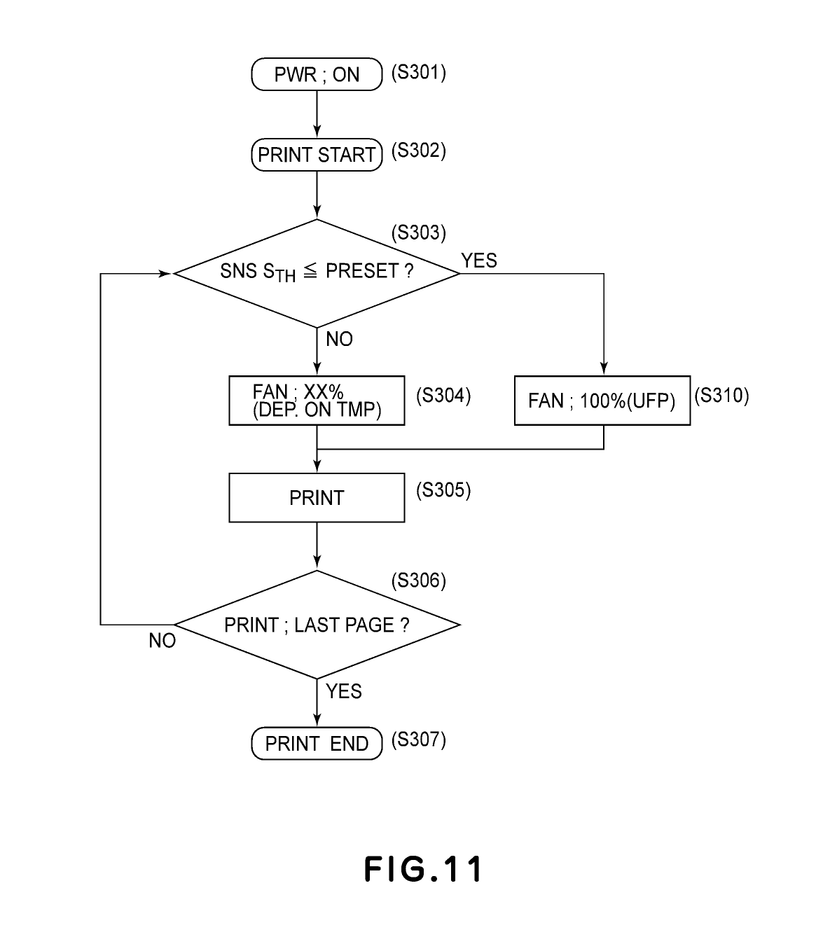

In the third embodiment, the image forming apparatus 100 is provided with a temperature sensor (fixation temperature sensor) S_{TH} for detecting the temperature of the adjacencies of the recording medium entrance of the fixing device 5, which is the fixing section, as will be evident from the block diagram of the fan control system (FIG. 3). FIG. 10 is a schematic sectional view of the fixing device 5, exhaust ducts, and their adjacencies, at a plane parallel to the recording medium conveyance direction, as seen from the front side, and FIG. 11 is a flowchart of the control in the third embodiment.

Referring to FIG. 10, in the third embodiment, the temperature sensor S_{TH} which is capable of detecting the ambient temperature of the fixation nip of the fixing device 5 is provided. The control section 200 can directly determine, with the use of this temperature sensor S_{TH}, whether or not the fixing device 5 has sufficiently cooled down.

Referring to FIG. 11, steps S301 and S302 are the same as the steps S101 and S102, respectively, in the flowchart in FIG. 8. In the step S303, the control section 200 determines, based on the output (related to detected temperature level) of the temperature sensor S_{TH}, whether or not the fixing device 5 has is in the cool state. That is, if the output of the temperature sensor S_{TH} is no higher than a preset temperature, the control section 200 determines that the amount of dust generation is large, and drives the exhaust fan 90, with the drive duty set to 100% (maximum speed) (S310).

The control section 200 carries out the printing operation while driving the exhaust fan 90 at the maximum speed (S305). Then, it determines whether or not the print is the last page (S306). If the print is not the last page, the control section 200 goes back to the step S303 in which it checks the output of the temperature sensor S_{TH}.

If the output of the temperature sensor S_{TH} is higher than a preset temperature, the control section 200 determines that the fixing device 5 has sufficiently warmed up for the amount of dust generation to be normal. Then, it sets the drive duty for the exhaust fan 90 according to the output of the developing device temperature detection sensor 38, and continues the printing operation (S305). If it determines in the step S306 that the print is the last page, it ends the printing operation (S307: PRINTEND).

Regarding the control of the fan 90 in this embodiment, the image forming apparatus 100 has the temperature sensor S_{TH} for detecting the ambient temperature of the recording medium entrance of the fixing means 5. The control section 200 controls the exhaust fan 90 in the following manner. That is, when the control section 200 makes the image forming apparatus 100 perform an image formation job for forming images on a preset number of sheets of recording medium, it activates the fan 90 in such a manner that the speed, at which the fan 90 is driven when the temperature detected by the temperature sensor S_{TH} when an image formation job was started is no higher than a preset value, becomes higher than the speed at which the fan 90 is driven when the temperature detected by the temperature sensor S_{TH} is no less than the preset level.

The control section 200 controls the fan 90 based on the temperature detected by the temperature sensor S_{TH} when the control section 200 received a command for making the image forming apparatus to do an image formation job.

The control section 200 controls the fan 90 based on the temperature detected by the temperature sensor S_{TH} when the control section 200 begins to activate the fixing section 5 to do an image formation job.

Therefore, it becomes unnecessary to predict the state of the fixing device 5, based on the length of time which has elapsed since the outputting of the last print in the immediately preceding image formation job. Therefore, it is possible to drive the fan 90 at a proper level of drive duty, only when the fan 90 needs to be driven.

According to the third embodiment, it is possible to prevent the problem that as the dust which originates from the parting agent contained in toner fills up the internal space of the image forming apparatus, the image forming apparatus is reduced in image quality. It is also possible to reduce the problem that the dust is unintentionally allowed to leak out of the image forming apparatus through the gaps or the like of the apparatus. Further, in a case where an image formation job is done when the ambient temperature of the recording medium entrance of the fixing section is higher than a preset level, the noise attributable to the increase in the speed at which the fan is driven can be minimized. Further, it is possible to minimize the amount of electric power necessary to drive the fan.

### [Miscellanies]

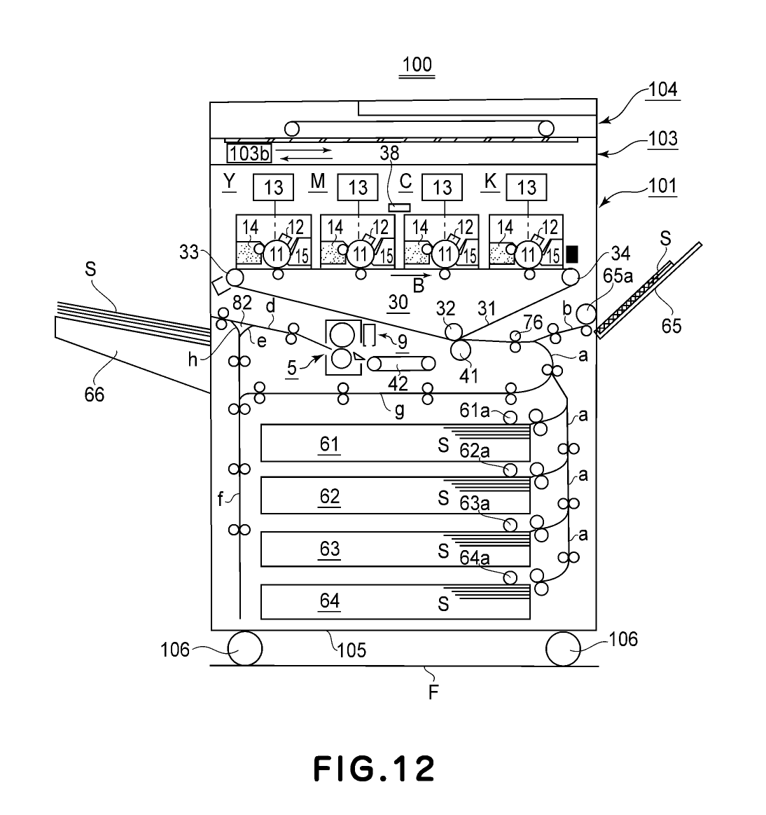

1) FIG. 12 is a schematic sectional view of an image forming apparatus which is practically the same as the image forming apparatus 100 shown in FIG. 1, except that the apparatus shown in FIG. 12 is provided with four sheet feeding/conveying cassettes 61-64, which are in the form of a drawer and are vertically stacked. Otherwise, the apparatus shown in FIG. 12 is the same in structure as the apparatus shown in FIG. 1.
2) The image formation section which forms a toner image on a sheet of recording medium is not limited to an electrophotographic image formation process system. It may be an image formation process system which forms a toner image on a sheet of recording medium with the use of an image formation process based on a suitable image formation principle/method, such as an electrostatic recording image formation process, a magnetic recording image formation process, along with a transfer method or a direct method.

The fixing section which fixes the toner image on a sheet of recording medium is not limited to an example which fixes the unfixed toner image formed on a sheet of recording medium to the sheet S to turn the unfixed toner image into a permanent image. It can be used as an apparatus for improving in gloss a fixed toner image on a sheet of recording medium, by reheating the toner image (in this embodiment, even in this case, the fixing device is referred to as a fixing section).

While the invention has been described with reference to the structures disclosed herein, it is not confined to the details set forth, and this application is intended to cover such modifications or changes as may come within the purposes of the improvements or the scope of the following claims.

This application claims priority from Japanese Patent Application No. 185062/2012 filed Aug. 24, 2012 which is hereby incorporated by reference.

What is claimed is:

1. An image forming apparatus comprising:
an image forming station configured to form a toner image on a recording material using toner containing a parting material;
a fixing portion configured to heat-fix the toner image formed on the recording material by said image forming station;
a fan configured and positioned to discharge air adjacent said fixing portion to an outside of said apparatus through a discharging path;
a filter provided in said discharging path; and
a controller capable of executing an operation in a first control mode in which a driving speed of said fan is changed in a set range in accordance with information corresponding to a temperature adjacent said image forming station which temperature rises with operation of the fixing portion, and in a second control mode in which the driving speed of said fan set at an upper limit speed in the set range irrespective of the information corresponding to the temperature adjacent said image forming station.

2. An apparatus according to claim 1, wherein said controller executes the second control mode in a first image formation job after actuation of a main voltage source.

3. An apparatus according to claim 2, wherein when the first image formation job is to continuously form images on a plurality of recording materials, said controller executes the operation in the second control mode until the image formation on a predetermined number of recording materials finishes, and executes the operation in the first mode thereafter.

4. An apparatus according to claim 2, wherein when the first image formation job is to continuously form images on a plurality of recording materials, said controller executes the operation in the second control mode until a predetermined time elapses, and executes the operation in the first mode thereafter.

5. An apparatus according to claim 1 or wherein a current image formation job is executed after a predetermined time elapses from completion of a last image formation job, said controller executes the operation in the second control mode.

6. An apparatus according to claim 5, wherein the current image formation job is to continuously form the images on the recording materials, said controller executes the operation in the second control mode until the image formation on a predetermined number of recording materials finishes, and executes the operation in the first mode thereafter.

7. An apparatus according to claim 5, wherein the current image formation job is to continuously form the images on the recording materials, said controller executes the operation in the second control mode until a predetermined time elapses, and executes the operation in the first mode thereafter.

8. An apparatus according to claim 1, further comprising a temperature sensor configured and positioned to detect the temperature adjacent said image forming station.

9. An apparatus according to claim 8, wherein said image forming station includes a developing portion configured and positioned to develop an electrostatic image formed on the image bearing member with toner, and said temperature sensor is disposed adjacent said developing portion.

10. An apparatus according to claim 1, further comprising a counting portion configured to count a number of continuous image formations as the information corresponding the temperature adjacent said image forming station, wherein said controller changes the driving speed of said fan in the set range in accordance with an output of said counting portion in the first control mode.

11. An apparatus according to claim 1, further comprising a measurement portion configured to measure time during which a continuous image formation is carried out, into information corresponding to the temperature adjacent said image forming station, wherein said controller changes the driving speed of said fan in the set range in accordance with an output of said measurement portion in the first control mode.

12. An apparatus according to claim 1, wherein said fixing portion includes a heating portion, and a operation of said fixing portion is changed to a stand-by mode in which electric power supply to said heating portion upon completion of the image formation.

13. An apparatus according to claim 1, wherein the toner contains wax as the parting material.

14. An image forming apparatus comprising:
an image forming station configured to form a toner image on a recording material using toner containing a parting material;
a fixing portion configured to heat-fix the toner image formed on the recording material by said image forming station;
a fan configured and positioned to discharge air adjacent said fixing portion to an outside of said apparatus through a discharging path;
a filter provided in said discharging path; and
a controller configured to control said fan in which a driving speed of said fan when an image formation is carried out on a predetermined number of recording materials before a predetermined time elapses from completion of a last image formation job is higher that when the image formation is carried out on the predetermined number of recording materials before the predetermined time elapses from completion of the last image formation job.

15. An apparatus according to claim 14, further comprising a storing portion configured to store time and date at the completion of the last image formation job, wherein said controller calculates the elapsed time using the stored time and date, and controls said fan in accordance with the calculated time.

16. An apparatus according to claim 14, further comprising a measurement portion configured to measure time elapsed from the completion of the last image formation job, said controller controls said fan in accordance with the time measured by said measurement portion.

17. An apparatus according to claim 14, wherein the toner contains wax as the parting material.

18. An image forming apparatus comprising:
an image forming station configured to form a toner image on a recording material using toner containing a parting material;
a fixing portion configured to heat-fix the toner image formed on the recording material by said image forming station;
a fan configured and positioned to discharge air adjacent said fixing portion to an outside of said apparatus through a discharging path;
a filter provided in said discharging path;
a temperature sensor configured and positioned to detect a temperature adjacent an entrance of the recording material to said fixing portion; and
a controller configured to control said fan in which when an image formation job is carried out on a predetermined number of recording material, said fan is operated in which a driving speed of said fan in the case that a detected temperature of the temperature sensor upon start of the image formation job is not higher than a predetermined temperature is higher than in the case that the detected temperature is higher than the predetermined temperature.

19. An apparatus according to claim 18, wherein said controller controls said fan on the basis of the temperature detected by said temperature sensor when said controller receives execution instructions for the image formation job.

20. An apparatus according to claim 18, wherein when said fixing portion is operated to carry out the image formation job, said controller controls said fan on the basis of a temperature detected by said temperature sensor.
